(19) United States
(12) Patent Application Publication
(10) Pub. No.: US 2013/0202256 A1
(43) Pub. Date: Aug. 8, 2013

(54) OPTICAL INTERCONNNECTION TRANSCEIVER MODULE

(71) Applicants: Fang-Jeng Lin, Taichung (TW); Tsu-Hsiu Wu, Taichung (TW)

(72) Inventors: Fang-Jeng Lin, Taichung (TW); Tsu-Hsiu Wu, Taichung (TW)

(73) Assignee: UNIVERSAL MICROELECTRONICS CO., LTD., Taichung (TW)

(21) Appl. No.: 13/365,368

(22) Filed: Feb. 3, 2012

(51) Int. Cl. G02B 6/43

(52) U.S. Cl. 385/89

(57) ABSTRACT

An optical interconnection transceiver module comprises a printed circuit board, a carrier, an optical interconnection device and a light-guiding module. The printed circuit board comprises a first area and a second area. The carrier is disposed at the first area of the printed circuit board to make the flexibility of the first area lower than that of the second area. The optical interconnection device is disposed on the carrier and electrically connected with the printed circuit board. The light-guiding module comprises a case disposed on the carrier and at least one reflective mirror. The case comprises a first accommodating slot, a first light channel and a second light channel in communication with the first accommodating slot and the first light channel. The reflective mirror is disposed at the first light channel, and the optical interconnection device is corresponded to the reflective mirror via the first light channel.

### FIELD OF THE INVENTION

The present invention is generally related to an optical interconnection module, which particularly relates to the optical interconnection module capable of preventing a light beam inclination.

### BACKGROUND OF THE INVENTION

With reference to FIG. 1, a conventional optical interconnection transceiver module 200 comprises a printed circuit board 210, a plurality of optical transmission devices 220, a lid 230, a plurality of lenses 240, and a plurality of fibers 250. The optical transmission devices 220 and the lid 230 are disposed at the printed circuit board 210, and the optical transmission device 220 is electrically connected with the printed circuit board 210. Each of the optical transmission devices 220 comprises a transmission surface 221, each of the fibers 250 comprises an end surface 251, and the transmission surface 221 and the end surface 251 are faced toward the lens 240. Each of the optical transmission devices 220 is driven by the printed circuit board 210 and radiates a light beam. Mentioned light beam travels into the fiber 250 via focus of the lens 240. However, an uneven stress distribution for a printed circuit board 210 is likely occurred in high temperature manufacturing procedure, which enables the printed circuit board 210 to become warped. For the reason that the optical transmission devices 220 are directly disposed at warped printed circuit board 210, a deviation of the radiated light beam is occurred and leads the light transmission efficiency to drop substantially.

### SUMMARY

The primary object of the present invention is to provide an optical interconnection transceiver module comprising a printed circuit board, a carrier, at least one optical interconnection device, and a light-guiding module, wherein the printed circuit board comprises a first area and a second area. The carrier comprises a first surface and is disposed at the first area to make the flexibility of the first area lower than that of the second area. The optical interconnection device is disposed at the first surface of the carrier and electrically connected with the printed circuit board. The light-guiding module comprises a case and at least one reflective mirror, wherein the case is disposed at the carrier and covers the optical interconnection device. The case comprises an upper surface, a lower surface, a first accommodating slot recessed from the lower surface, a first light channel and a second light channel in communication with the first light channel and the accommodating slot. The reflective mirror is disposed at the first light channel, and the optical interconnection device is corresponded to the reflective mirror via the first light channel. For the reason that the carrier is disposed at the first area of the printed circuit board, the flexibility of the first area declines substantially. Therefore, when the optical interconnection device is disposed at the carrier, an optical inclination for the optical interconnection device will not be occurred due to the flexibility of the first area much smaller than that of the second area. Accordingly, the light path will not be deviated while a light transmission is proceeding.

### DESCRIPTION OF THE DRAWINGS

FIG. 1 is a lateral view illustrating a conventional optical interconnection transceiver module.

FIG. 2 is a perspective exploded view illustrating an optical interconnection transceiver module in accordance with a preferred embodiment of the present invention.

FIG. 3 is a perspective assembly view illustrating the optical interconnection transceiver module in accordance with a preferred embodiment of the present invention.

FIG. 4 is a lateral section view illustrating the optical interconnection transceiver module in accordance with a preferred embodiment of the present invention.

FIG. 5 is another lateral section view illustrating the optical interconnection transceiver module with a preferred embodiment of the present invention.

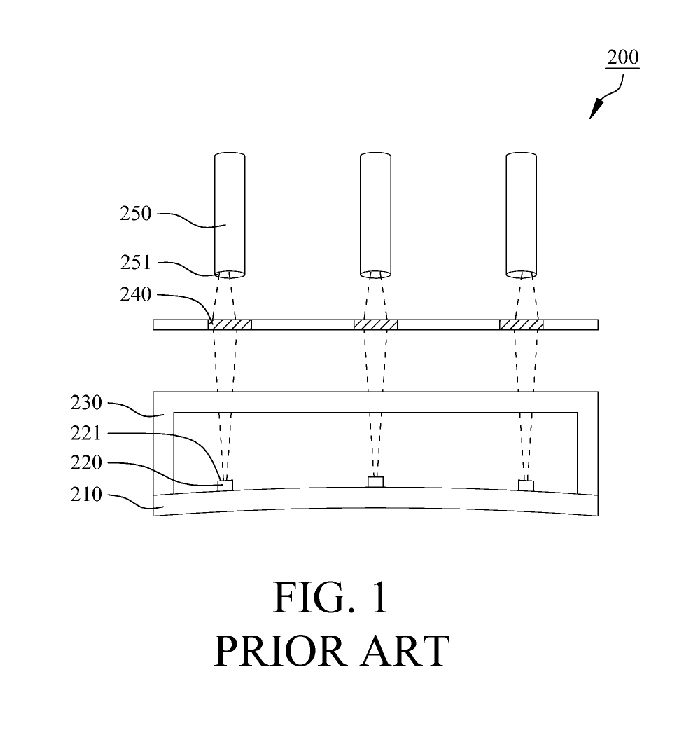

### DETAILED DESCRIPTION OF THE INVENTION

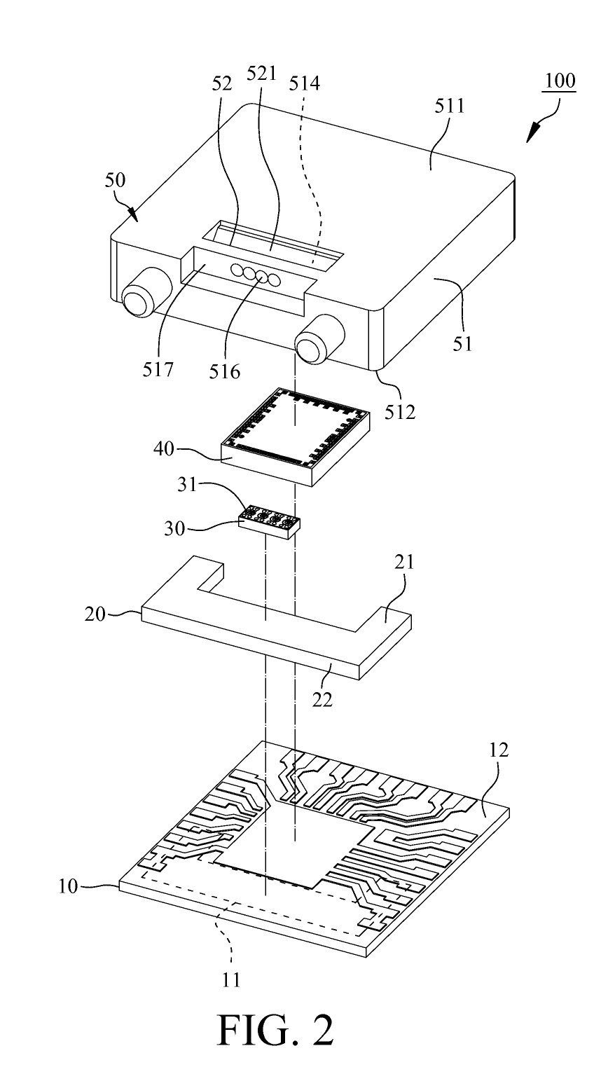

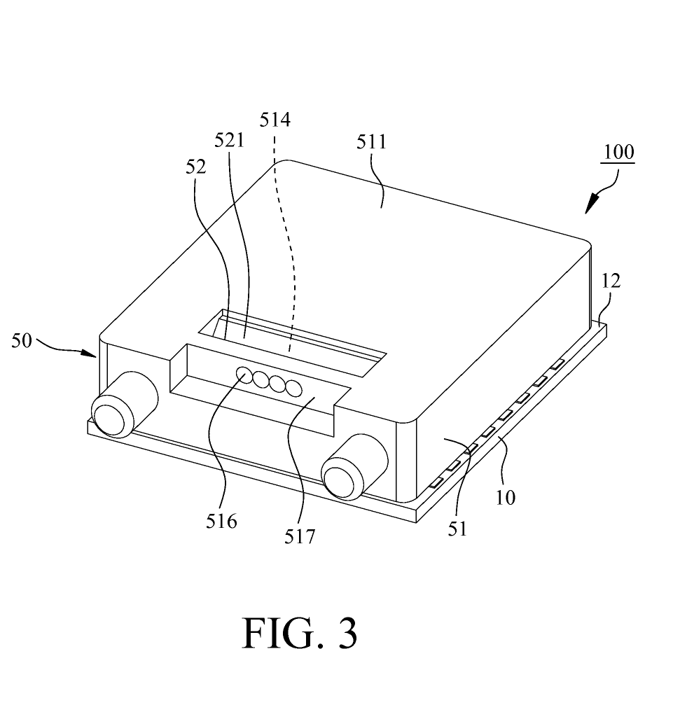

With reference to FIGS. 2, 3 and 4, an optical interconnection transceiver module 100 in accordance with a preferred embodiment of the present invention comprises a printed circuit board 10, a carrier 20, at least one optical connection device 30, and a light-guiding module 50, wherein the printed circuit board 10 comprises a first area 11 and a second area 12. The carrier 20 comprises a first surface 21 and is disposed at the first area 11 of the printed circuit board 10 to make the flexibility of the first area 11 smaller than that of the second area 12. The optical connection device 30 is disposed on the first surface 21 of the carrier 20. In this embodiment, the optical connection device 30 is electrically connected with the printed circuit board 10. Preferably, the optical connection device 30 is electrically connected with the printed circuit board 10 through the carrier 20. The light-guiding module 50 comprises a case 51 and at least one reflective mirror 52, wherein the case 51 is disposed on the carrier 20 and covers the optical connection device 30. The case 51 comprises an upper surface 511, a lower surface 512, a first accommodating slot 513 recessed from the lower surface 512, a first light channel 515, and a second light channel 516 in communication with the first light channel 515 and the first accommodating slot 513. The reflective mirror 52 is disposed at the first light channel 515, and the optical connection device 30 is corresponded to the reflective mirror 52 via the first light channel 515. Preferably, the case 51 further comprises a second accommodating slot 514 recessed from the upper surface 511, said first light channel 515 is in communication with the second accommodating slot 514, and the reflective mirror 52 is attached to the first light path 515 via the second accommodating slot 514. With reference to FIG. 2, the optical interconnection transceiver module 100 further comprises a driving IC 40, said driving IC 40 is disposed at the second area 12 and electrically connected with the printed circuit board 10. In this embodiment, the optical connection device 30 is electrically connected with the driving IC 40 through the carrier 20.

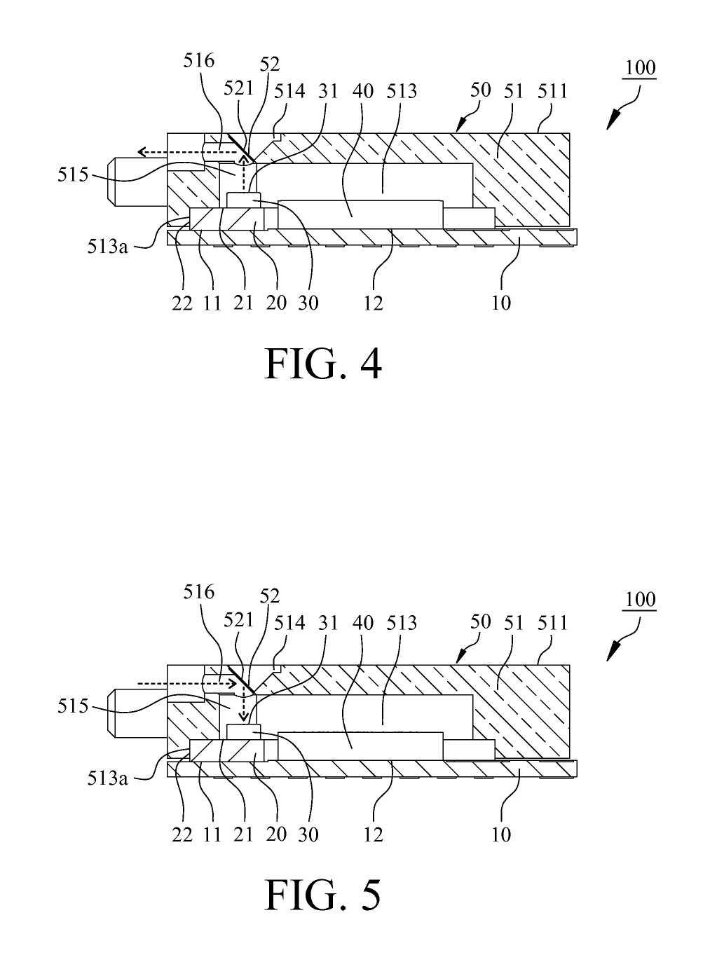

Referring to FIG. 4 again, the optical connection device 30 comprises a second surface 31, the reflective mirror 52 comprises a ramp surface 521, and the second surface 31 of the optical connection device 30 faces toward the ramp surface 521 of the reflective mirror 52. In addition, the first accommodating slot 513 comprises an inner surface 513a, the carrier 20 comprises a lateral surface 22, and the inner surface 513a of the first accommodating slot 513 is in contact against the lateral surface 22 of the carrier 20. Via mutual contact of the inner surface 513a and the lateral surface 22, the structural stability for the carrier 20 and the case 51 can be effectively enhanced. In usual semiconductor manufacturing process, after curing, laminating, and heating the printed circuit board 10, a warp phenomenon may be likely occurred from the printed circuit board 10 by means of uneven stress distribution. Once the optical connection device 30 directly disposed on warped printed circuit board 10, an inclined transmitting/receiving light path for the optical connection device 30 enables the light transmission efficiency to drop substantially. In order to have this problem solved, in this embodiment, the carrier 20 is disposed at the first area 11 of the printed circuit board 10, which lowers the flexibility of the first area 11. Therefore, the flexibility of the first area 11 is much lower than that of the second area 12. Besides, the carrier 20 is made of silica materials. Owning to the reason that the silica materials possess characteristic of low flexibility, when the optical interconnection device 30 is disposed on silica-made carrier, and mentioned carrier 20 disposes at the first area 11 of the printed circuit board 10, an optical inclination for the optical interconnection device 30 will be eliminated, therefore, the light path will not be deviated as well.

With reference to FIG. 4 again, in this embodiment, the light interconnection device 30 can be a light-emitting diode (LED) or a laser diode (LD). The light interconnection device 30 is driven by the driving IC 40 and radiates a light beam. Mentioned light beam travels along the first light channel 515 and contacts the reflective mirror 52. In this embodiment, the first light channel 515 and the second light channel 516 are mutually perpendicular. Besides, the reflective mirror 52 can be a total reflection mirror so that the light beam is reflected by the total reflection mirror and travels toward the second channel 516. Eventually, the light beam is received by an external fiber (not shown in Figs.) thereby achieving a high light transmission. With reference to FIG. 5, in this embodiment, the light interconnection device 30 can be a photo-detector (PD). A light beam transmitted from an external fiber (not shown in Fig.) travels into the second light channel 516 and contacts the reflective mirror 52. For the reason that the reflective mirror 52 is a total reflection mirror, mentioned light beam is reflected by the total reflection mirror and travels through the first light channel 515. Eventually, the traveled light beam is received by the optical interconnection device 30 to achieve a high light receiving efficiency.

An uneven stress distribution for a printed circuit board 10 is likely occurred in high temperature manufacturing procedure, which enables the printed circuit board 10 to become warped. In this invention, for the reason that the carrier 20 is disposed at the first area 11 of the printed circuit board 10, the flexibility of the first area 11 declines substantially. Therefore, when the optical interconnection device 30 is disposed at the carrier 20, an optical inclination for the optical interconnection device 30 will be eliminated due to the flexibility of the first area 11 much smaller than that of the second area 12. Accordingly, the light path will not be deviated while a light transmission/receiving is proceeding.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. An optical interconnection transceiver module comprising:
a printed circuit board having a first area and a second area;
a carrier having a first surface, said carrier is disposed at the first area to make the flexibility of the first area lower than the flexibility of the second area;
at least one optical interconnection device disposed at the first surface of the carrier and electrically connected with the printed circuit board; and
a light-guiding module having a case and at least one reflective mirror, wherein the case is disposed at the carrier and covers the optical interconnection device, said case comprises an upper surface, a lower surface, a first accommodating slot recessed from the lower surface, a first light channel and a second light channel in communication with the first light channel and the first accommodating slot, said reflective mirror is disposed at the first light channel, and the optical interconnection device is corresponded to the reflective mirror via the first light channel.

2. The optical interconnection transceiver module in accordance with claim 1, wherein the optical interconnection device is electrically connected with the printed circuit board through the carrier.

3. The optical interconnection transceiver module in accordance with claim 1 further comprises a driving IC, said driving IC is disposed at the second area of the printed circuit board and electrically connected with the printed circuit board.

4. The optical interconnection transceiver module in accordance with claim 3, wherein the optical interconnection device is electrically connected with the driving IC through the carrier.

5. The optical interconnection transceiver module in accordance with claim 1, wherein the optical interconnection device comprises a second surface, the reflective mirror comprises a ramp surface, and the second surface of the optical interconnection device faces toward the ramp surface of the reflective mirror.

6. The optical interconnection transceiver module in accordance with claim 1, wherein the first light channel and the second light channel are mutually perpendicular.

7. The optical interconnection transceiver module in accordance with claim 1, wherein the first accommodating slot comprises an inner surface, the carrier comprises a lateral surface, and the inner surface of the first accommodating slot is in contact against the lateral surface of the carrier.

8. The optical interconnection transceiver module in accordance with claim 1, wherein the optical interconnection device can be a light-emitting diode or a laser diode.

9. The optical interconnection transceiver module in accordance with claim 1, wherein the carrier is made of silica materials.

10. The optical interconnection transceiver module in accordance with claim 1, wherein the optical interconnection device can be a photo-detector. 11. The optical interconnection transceiver module in accordance with claim 1, wherein the reflective mirror can be a total reflection mirror.
